(19) United States
(12) Patent Application Publication
(10) Pub. No.: US 2014/0102225 A1
(43) Pub. Date: Apr. 17, 2014

(54) Sensor device

(71) Applicants: Peter KUNERT, Lichtenstein (DE); Martin Rojahn, Tuebingen (DE)

(72) Inventors: Peter KUNERT, Lichtenstein (DE); Martin Rojahn, Tuebingen (DE)

(73) Assignee: Robert Bosch GmbH, Stuttgart (DE)

(21) Appl. No.: 14/056,557

(22) Filed: Oct. 17, 2013

(30) Foreign Application Priority Data
Oct. 17, 2012 (DE) 10 2012 218 929.7

(51) Int. Cl. G01D 11/30

(52) U.S. Cl. CPC G01D 11/30
USPC 73/866.5

(57) ABSTRACT

A sensor device, having a sensor component, and a fastening element, in which the fastening element is configured as a receptacle for the sensor component and as a fastening arrangement for the sensor device.

### RELATED APPLICATION INFORMATION

The present application claims priority to and the benefit of German patent application no. 10 2012 218 929.7, which was filed in Germany on Oct. 17, 2012, the disclosure of which is incorporated herein by reference.

### FIELD OF THE INVENTION

The present invention relates to a sensor device.

### BACKGROUND INFORMATION

Sensors for detecting physical variables such as e.g. rotational speed, acceleration, pressure etc. are installed in plastic housings, which are mounted in a motor vehicle using screws and are electrically contacted by a plug. For example, in a so-called peripheral acceleration sensor of the sixth generation (“PAS6”), an electrical sensor unit is formed, which includes a MEMS acceleration chip, an ASIC as well as passive components, which all are combined in an LGA (land grid array) enveloped or molded using an injection molding process. The LGA is fixed in place by electrically conductive insertion parts (ELT), which at the same time act as electrical control contacts toward the outside. The LGA fixed in place and electrically contacted by the insertion parts is extrusion coated by a thermosetting plastic material. Subsequently, this unit (a so-called “lolly”) is extrusion coated by a thermosetting plastic material, which acts as a housing having sockets and as a plug unit of the sensor.

German patent document DE 10 2009 027 995 A1 discusses a device having a semiconductor component and a housing, the housing having at least one electrical terminal and at least one fastening point. The housing has a first shell made of thermosetting plastic, which essentially encloses the semiconductor component.

### SUMMARY OF THE INVENTION

According to a first aspect, the present invention creates a sensor device, having a sensor component and a fastening element. The sensor device is characterized by the fact that the fastening element is developed as a receptacle for the sensor component and as a fastening means for the sensor device.

According to a second aspect, the present invention provides for a use of a sensor device, the sensor device being fastened essentially in parallel to a sensing axis in an object to be sensed, at least one acceleration value or rate-of-rotation value being sensed by the sensor device.

Further developments of the present invention are the subject matter of dependent claims.

One specific embodiment of the sensor device is characterized by the fact that the fastening element is developed to be screw-shaped or bolt-shaped. This advantageously provides the sensor device with a sensing axis that is particularly simple to adjust and which may extend in longitudinal axis of the sensor device. Moreover, this supports a simple and secure fastening of the sensor device by a screw-in process or by a press fit. The screw shape makes it possible to achieve a very high accuracy of fit of the sensor device in the automobile.

One specific embodiment of the sensor device according to the present invention is characterized by the fact that the fastening element is made of a plastic material. This advantageously provides for a more cost-effective manufacturing option for the sensor device.

One specific embodiment of the sensor device according to the present invention is characterized by the fact that the fastening element is made of metal. This advantageously supports a good mechanical stability and a good EMC protective action.

One specific embodiment of the sensor device according to the present invention is characterized by the fact that the sensor component has at least one positioning element. This advantageously allows for a defined arrangement of the sensor component within the fastening element. Moreover, the positioning element prevents an angularly incorrect insertion of the sensor component.

Another specific embodiment of the sensor device according to the present invention is characterized by the fact that the fastening element is at least partially hollow. This advantageously provides for a good fit and a good EMC shielding action for the sensor component.

Another advantageous development of the sensor device of the present invention is characterized by the fact that a hollow space of the fastening element is filled with a filler. This advantageously supports a good and durable fit of the sensor component within the sensor device, which advantageously supports sensing characteristics of the sensor device that are exact over the long term. This also advantageously increases a vibration-resistance, which particularly benefits inertial sensors.

One specific embodiment of the sensor device according to the present invention is characterized by the fact that the sensor device has a pre-injection mold. The pre-injection mold advantageously provides a stop edge for a filler injection process so as to support a precise and quick injection-filling of the remaining hollow space.

One specific embodiment of the sensor device according to the present invention is characterized by the fact that the sensor component includes at least one electrically conductive insertion part. This supports a simple electrical contacting option and an efficient EMC shield for the sensor component.

One specific embodiment of the sensor device is characterized by the fact that at least one wall of the fastening element has at least one hole. This advantageously allows for a gas exchange, for example during the injection, and for a pressure measurement within a remaining hollow space.

One specific embodiment of the sensor device is characterized by the fact that the sensor component is situated on a printed-circuit board. This facilitates soldering the sensor component. Moreover, the sensor component is thereby advantageously not enclosed in filler, which may have advantageously positive effects on a mechanical stress for the sensor component.

One advantageous further refinement of the sensor device is characterized by the development of an attachment of the printed-circuit board on a plug unit having at least one retaining element. This supports a secure and exact fit of the sensor component on the printed-circuit board.

One specific embodiment of the sensor device according to the present invention is characterized in that the plug unit and a head of the fastening element are disposed on the same end section or on opposite end sections of the sensor device. This advantageously supports a design variety, allowing for different plug connections for electrically contacting the sensor device.

It is regarded as particularly advantageous in the present invention that the fastening element assumes a dual function in that it acts both as a mechanically secure receptacle of the sensor component as well as to fasten the sensor device in an object to be sensed. This is advantageously associated with savings in term of space, which allows for an increased sensor density in modern automobiles. The specific form configuration of the sensor device additionally supports a quick and reliable installation of the sensor device and a comfortable electrical contacting of the sensor device using a plug. An assembly process of the sensor device is simple. Furthermore, it is possible to transport the sensor device cost-effectively.

Additional features and advantages of the present invention are explained below on the basis of specific embodiments and with reference to the figures. In this context, all of the described or represented features, alone or in any combination, form the subject matter of the present invention, regardless of their combination in the patent claims or their antecedent reference, and regardless of their wording and representation in the specification and in the figures. The figures are primarily intended to clarify the principles that are essential to the present invention and are not necessarily to be understood as diagrams true to scale and true to detail. In the figures, identical reference symbols denote identical or functionally equivalent elements.

### BRIEF DESCRIPTION OF THE FIGURES

FIG. 1 shows a specific embodiment of the sensor device according to the present invention.

FIG. 2 shows a representation in principle of a sensor device.

FIG. 3 shows another specific embodiment of the sensor device according to the present invention.

FIG. 4 shows another specific embodiment of the sensor device according to the present invention.

FIG. 5 shows another specific embodiment of the sensor device according to the present invention prior to an assembly.

FIG. 6 shows two additional specific embodiments of the sensor device according to the present invention.

### DETAILED DESCRIPTION

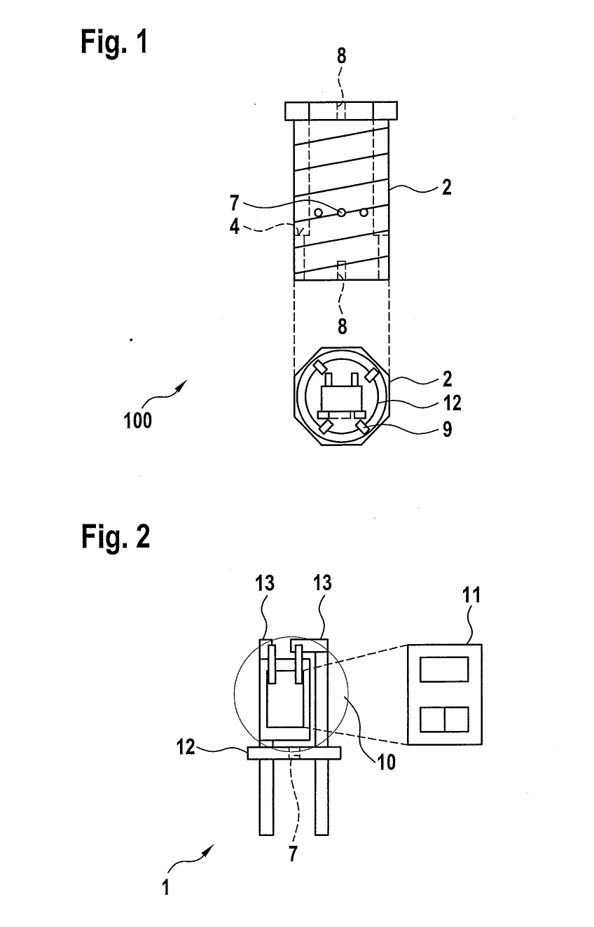

FIG. 1 shows a first specific embodiment of sensor device 10 according to the present invention in a top view. A fastening element 2 is developed in the shape of a screw having a thread, fastening element 2 having a hollow space for accommodating a sensor component 1. Multiple holes 7 are developed in a wall of fastening element 2 in order thereby to allow for an exchange of gas (for example an escape of air when introducing thermoplastic or a pressure measurement in the remaining hollow space of fastening element 2). Fastening element 2 furthermore has injection channels 8 for injecting or filling the hollow space of fastening element 2 using a filler (e.g. thermoplastic), injection channels 8 also allowing air to escape during the thermoplastic injection. Multiple positioning elements 9 are provided on sensor component 1, which define an orientation of sensor component 1 within fastening element 2. In addition, positioning elements 9 prevent an undesired, twisted insertion of sensor component 1 or of the “lolly” into fastening element 2.

FIG. 2 shows a construction in principle of sensor component 1, which is introduced into fastening element 2. Sensor device 1 includes an LGA 11 having micromechanical (MEMS) components for detecting physical variables (e.g. rate of rotation, pressure, acceleration etc.), an ASIC and passive components.

LGA 11 is held by two metallic insertion parts 13, insertion parts 13 also acting as electrical contacting elements for LGA 11 toward the outside. An extrusion coat 10 (e.g. of thermosetting plastic material) is used to fix LGA 11 mechanically in place. A pre-injection mold 12 acts as a fill stop for the filler to be introduced later within fastening element 2.

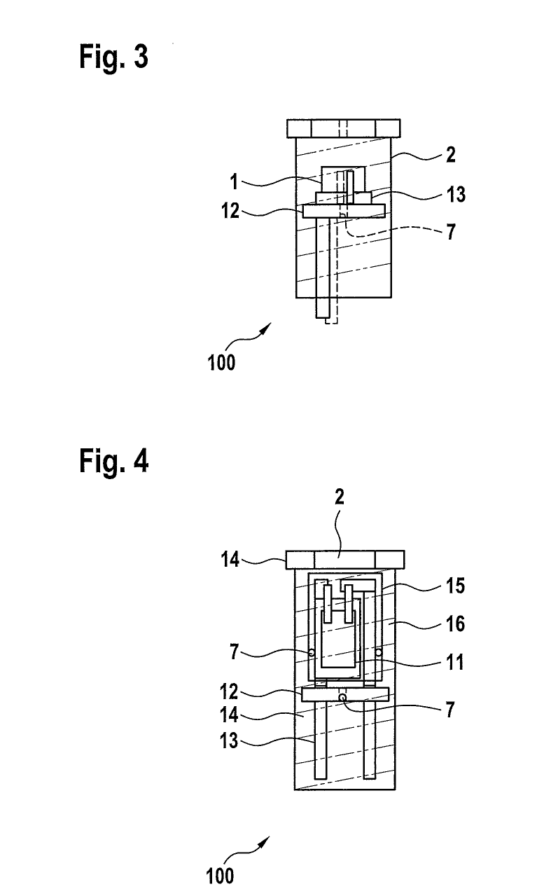

FIG. 3 shows the first specific embodiment of the completely mounted sensor device 100. It can be seen that insertion part 13 is bent so as to allow for an exact angular orientation of sensor component 1 within fastening element 2 for the physical variable to be sensed. Insertion parts 13 protrude downward out of fastening element 2 in order to act as electrical contacting elements. Insertion parts 13 are advantageously also provided for an EMC shielding of the LGA.

Sensor device 100 of the present invention may be mounted as follows:

First, sensor component 1 is assembled and subsequently extrusion-coated with extrusion coat 10 in order to form the “lolly”. Afterwards, sensor component 1 is inserted into the hollow screw-shaped or bolt-shaped fastening element 2. Finally, the remaining empty space is filled with thermoplastic from the head or from the tip of fastening element 2 by an injection molding process. Air may thereby escape from holes 7 in a screw thread or from a hole 7 of pre-injection mold 12 or from a gap in the region of a guide edge 4 for guiding pre-injection mold 12. Sensor component 1 is fixed in place during the injection by pre-injection mold 12 in the case where a sufficient mechanical rigidity is provided (due to the L profile of insertion parts 13). Otherwise, an additional fixing means may be required within fastening element 2.

The fully mounted sensor device 100 may be mounted in parallel with a spatial axis of a vehicle (x, y, or z axis). An electrical connection socket may be situated on or in the tip or in the head of fastening element 2. Such a fastening on the vehicle and an accordingly oriented arrangement of sensor component 1 within fastening element 2 allows for very exact sensing in the spatial axis. Sensor device 100 may in principle also be mounted in any exactly defined spatial direction of the vehicle in order to sense at least one vectorial measured variable simultaneously in two spatial directions.

As an alternative to the specific embodiment described above, it is also conceivable to dispense with mounting sensor component 1 in a provided hollow body. This may be achieved by injection-molding an outer plastic shell of sensor device 100 in the form of a screw or a bolt. Details of the screw/bolt, for example specific thread shapes or grooves used for positional accuracy of sensor device 100 in the installation in the vehicle, may be selected more easily in an injection molding process than by the separate process steps for the hollow body described above.

Advantageously, in contrast to the above-described specific embodiment, a separate mechanical part in the form of a hollow screw/bolt is then eliminated, whereby the manufacturing process may be simplified further. Moreover, sensor devices 100 injection molded in such a way in the form of a screw or bolt may be advantageously packaged in tape and reel.

FIG. 4 shows a possible specific embodiment of a sensor device 100 developed in this manner. In terms of an outer shape, this specific embodiment essentially corresponds to the specific embodiment of FIG. 1 or FIG. 3. What is different is that now a first plastic shell 15 is developed around Si chips and contacts. Furthermore, a second plastic shell 16 is provided, which may be developed in the form of a thermoplastic extrusion coat and may be screw-shaped or bolt-shaped. An electrical connection socket or plug cavity may be developed in a screw tip or in a screw head 14 and forms an injection-molded unit with the housing of sensor device 100. When needed, a hole 7 may also be provided in pre-injection mold 12 in this specific embodiment in order to allow for air to escape when injection-molding the second plastic shell 16.

Screw head 14 of a screw-shaped sensor device 100 may have different shapes. It is conceivable, for example, that screw head 14 extends/does not extend beyond the thread, or that it is developed as a cylinder head, an hexagon head, hexagon socket etc.

The specific embodiment of the sensor device shown in FIG. 4 may be manufactured as follows:

First, LGA 11 is mounted on metallic insertion parts 13. Subsequently, LGA 11 is extrusion-coated with thermosetting plastic so as to form first plastic shell 15. Afterwards, the outer, second plastic shell 16 is manufactured (e.g. from thermoplastic) in an injection molding process.

As another variant of sensor device 100, sensor component 1 may be fastened with a printed-circuit board (PCB) 17 in a hollow body. For this purpose, using press-in technology, printed-circuit board 17 is mechanically fixed in place and electrically contacted by insertion parts 13. This makes it possible to use sensor modules that were developed for printed-circuit board 17. A mechanical connection of sensitive rate-of-rotation sensor modules remains advantageously unchanged. Advantageously, this minimizes development risks with respect to mechanical/thermal stress, natural modes of the sensor module carrier system etc. At the same time, it is possible to use the advantages of the integration of sensor component 1 in a hollow screw.

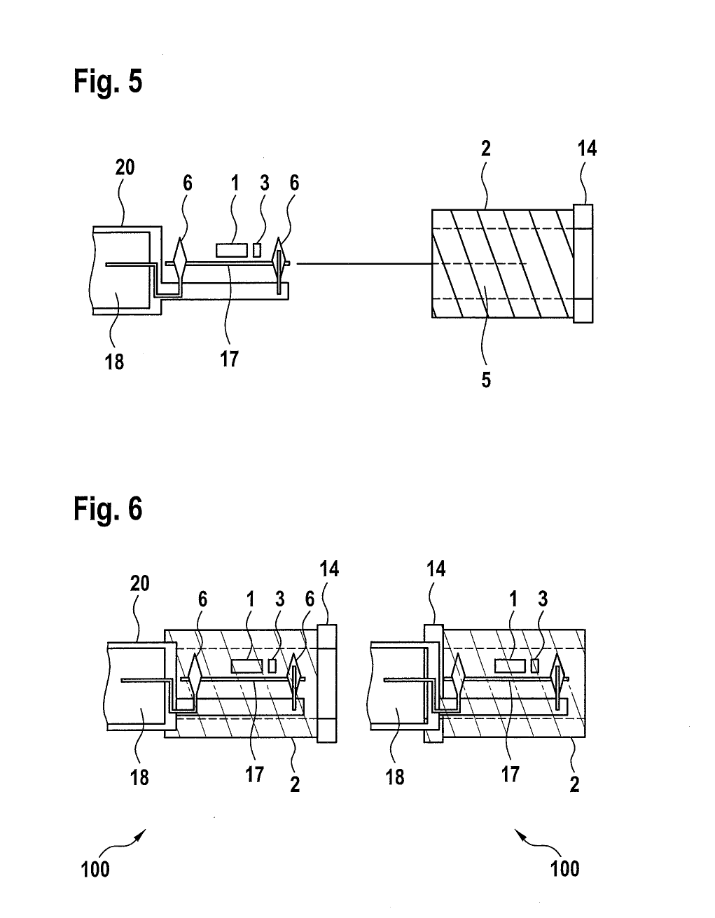

FIG. 5 show such a development of a sensor device 100 prior to assembly.

A plug unit 20 is provided, in which a printed-circuit board 17 is fastened for retaining sensor component 1 and additional passive components 3. Printed-circuit board 17 is fastened on plug unit 20 by retaining elements 6. Following a preassembly of plug unit 20, the entire plug unit 20 is inserted into hollow fastening element 2. Subsequently, a tight, integral joint is produced between plug unit 20 and fastening element 2. Possible joining methods for this purpose are e.g. laser transmission welding (LTW) or other integral joining technologies such as, for example, ultrasonic welding, adhesive bonding etc.

In contrast to the specific embodiments described above, a mechanically stress-optimized construction of sensor component 1 is thereby achieved due to the fact that sensor component 1 is not enclosed in a filler.

In two detailed views, FIG. 6 shows possible arrangements of a screw head of screw-shaped sensor device 100. In the left variant, it can be seen that the screw head is situated on an opposite end of a plug socket cavity 18 formed of plastic. In this case, an electric contacting from outside is no longer possible once sensor device 100 has been screwed in.

In the variant represented on the right in FIG. 6, screw head 14 is situated on the same side as plug socket cavity 18. In this case, an electrical contact may be established via plug socket cavity 18.

In summary, the present invention provides for a sensor device that entails a substantially improved arrangement of a sensor component in a component assembly. For according to the present invention an outer shape of the sensor device forms both a receiving element for the sensor component as well as a fastening element for the entire sensor device.

The essentially elongated development of the sensor device allows for a simple and accurate development of a sensing behavior along a defined spatial coordinate when the sensor device is fastened in parallel to this defined coordinate. The construction according to the present invention supports a space-saving implementation of the sensor device, which allows for a greater sensor density in the motor vehicle.

The sensor device according to the present invention may be fastened in a suitable location of an object to be sensed (for example a B beam or a center console of a motor vehicle).

Advantageously, the sensor device of the present invention makes it possible to use hollow spaces in vehicle profiles that were hitherto inaccessible since only the plug end must be accessible for installation, and no additional attachment nuts need to be accessible as in conventional sensors.

Although the present invention was described with reference to exemplary embodiments, it is not limited to these. One skilled in the art will therefore be able to modify or combine with one another the described features of the present invention without deviating from the essence of the present invention.

What is claimed is:

1. A sensor device, comprising:
a sensor arrangement, including:
a sensor component; and
a fastening element;
wherein the fastening element includes a receptacle for the sensor component and as a fastening arrangement for the sensor arrangement.

2. The sensor device of claim 1, wherein the fastening element is configured to be screw-shaped or bolt-shaped.

3. The sensor device of claim 1, wherein the fastening element is made of a plastic material.

4. The sensor device of claim 1, wherein the fastening element is made of metal.

5. The sensor device of claim 1, wherein the sensor component has at least one positioning element.

6. The sensor device of claim 1, wherein the fastening element is at least partially hollow.

7. The sensor device of claim 6, wherein a hollow space of the fastening element is filled with a filler.

8. The sensor device of claim 1, wherein the sensor component has a pre-injection mold.

9. The sensor device of claim 1, wherein the sensor component includes at least one electrically conductive insertion part.

10. The sensor device of claim 6, wherein at least one wall of the fastening element has at least one hole.

11. The sensor device of claim 1, wherein the sensor component is situated on a printed-circuit board.

12. The sensor device of claim 11, wherein an attachment of the printed-circuit board is configured on a plug unit having at least one retaining element.

13. The sensor device of claim 11, wherein the plug unit and a head of the fastening element are situated on a same end section or on opposite end sections of the sensor device.

14. A sensor device, comprising:
a sensor arrangement, including:
a sensor component; and
a fastening element;
wherein the fastening element includes a receptacle for the sensor component and as a fastening arrangement for the sensor arrangement, and
wherein the sensor arrangement is fastened essentially in parallel to a sensing axis in an object to be sensed, at least one acceleration value or rate-of-rotation value being sensed by the sensor arrangement.
